(19) United States
(12) Patent Application Publication
(10) Pub. No.: US 2015/0052916 A1
(43) Pub. Date: Feb. 26, 2015

(54) SYSTEM AND METHOD FOR CONTROLLING AIR CONDITIONING SYSTEM

(71) Applicant: Caterpillar Inc., Peoria, IL (US)

(72) Inventors: Daniel A. Spurgeon, Washington, IL (US); Erick A. Njos, Washington, IL (US); Douglas J. Hovel, Lincoln, IL (US); Gerald R. Morris, Elmwood, IL (US)

(73) Assignee: Caterpillar Inc., Peoria, IL (US)

(21) Appl. No.: 13/974,643

(22) Filed: Aug. 23, 2013

(51) Int. Cl. B60H 1/32

(52) U.S. Cl. CPC B60H 1/3205
USPC 62/115; 62/126

(57) ABSTRACT

An air conditioning system for an operator cab of machine includes a condenser, an evaporator, a compressor and a controller operable to control an operation of the compressor. The controller maintains a pre-defined compressor run time when the compressor is in an ON state. The controller is configured to determine a temperature of the evaporator and compare it with at least one of a first lower threshold temperature value and a second lower threshold temperature value being less than the first lower threshold temperature value. The controller outputs a compressor control command signal to change the operational state of the compressor to an OFF state when the determined temperature of the evaporator is less than at least one of the first lower threshold temperature value for a first time period, and the second lower threshold temperature value for a second time period being less than the first time period.

### TECHNICAL FIELD

The present disclosure relates to an air conditioning system for an operator cab of a machine, and particularly to a system and method for controlling an operation of a compressor of the air conditioner system.

### BACKGROUND

Air conditioners have been very well known for cooling an environment, such as a car, a room or an operator cab of a machine, to which the air conditioner is fitted. Generally, air conditioners include an evaporator and a liquid refrigerant flowing through it and air flowing over it. The refrigerant in the evaporator absorbs the heat from the air, thereby cooling the air which may be flown into the environment using a fan. As the refrigerant absorbs heat from the air, it converts into vapor state. This vaporized refrigerant is compressed to be pressurized, in a compressor and routed through a condenser for cooling the refrigerant and to further enter into the evaporator via a throttle/expansion valve.

During run time of the compressor, excessive ice may be accumulated on the outer surface of the evaporator. Accumulation of ice on the outer surface of the evaporator may not be desired as it adversely affects the performance of the air conditioners and also reduces the life of the air conditioners. One way to reduce the excessive icing on the evaporator is to turn off the compressor. However, turning off the compressor too frequently would increase unnecessary strain on a driving mechanism of the compressor. Whereas, turning off the compressor for a long time may also effect the cooling the environment. Therefore, for effective cooling, turning off the compressor for a long time is not advisable.

U.S. Pat. No. 4,350,021 relates to a device for preventing icing in a thermostat-controlled evaporator in an air conditioning unit for motor vehicles including a first sensor for sensing the speed of the air through the evaporator and preferably also a second sensor for sensing the humidity of the air. A control unit sets the thermostat to a lowest permissible evaporator temperature which is dependent on the speed and humidity of the air.

### SUMMARY

In one aspect, an air conditioning system for use within an operator cab of a machine is provided. The air conditioning system includes a condenser, an evaporator, a compressor and a controller. The controller is operable to control an operation of the compressor. The controller is configured to determine an operational state of the compressor. The controller is further configured to selectively maintain a pre-defined compressor run time when the compressor in an ON state. The controller is configured to determine a temperature of the evaporator. The controller is further configured to compare the determined temperature of the evaporator with at least one of a first lower threshold temperature value and a second lower threshold temperature value being less than the first lower threshold temperature value. Furthermore, the controller is configured to output a compressor control command signal to change the operational state of the compressor to an OFF state when the determined temperature of the evaporator is less than at least one of the first lower threshold temperature value for a first time period, and the second lower threshold temperature value for a second time period being less than the first time period.

In another aspect, a method of operating an air conditioning system of a machine is provided. The method determines an operational state of a compressor of the air conditioning system. The method maintains a pre-defined compressor run time when the compressor is in an ON state. The method further determines a temperature of the evaporator and compares the determined temperature of the evaporator with at least one of a first lower threshold temperature value and a second lower threshold temperature value being less than the first lower threshold temperature value. Furthermore, the method outputs a compressor control command to turn the compressor to an OFF state when the determined temperature of the evaporator is less than at least one of the first lower threshold temperature value for a first time period, and the second lower threshold temperature value for a second time period being less than the first time period.

### BRIEF DESCRIPTION OF THE DRAWINGS

FIG. 1 illustrates a schematic view of an exemplary machine;

FIG. 2 illustrates a schematic view of an air conditioning system, according to an embodiment of the present disclosure; and

FIG. 3 illustrates an exemplary method of controlling operations of a compressor of the air conditioning system of FIG. 2.

### DETAILED DESCRIPTION

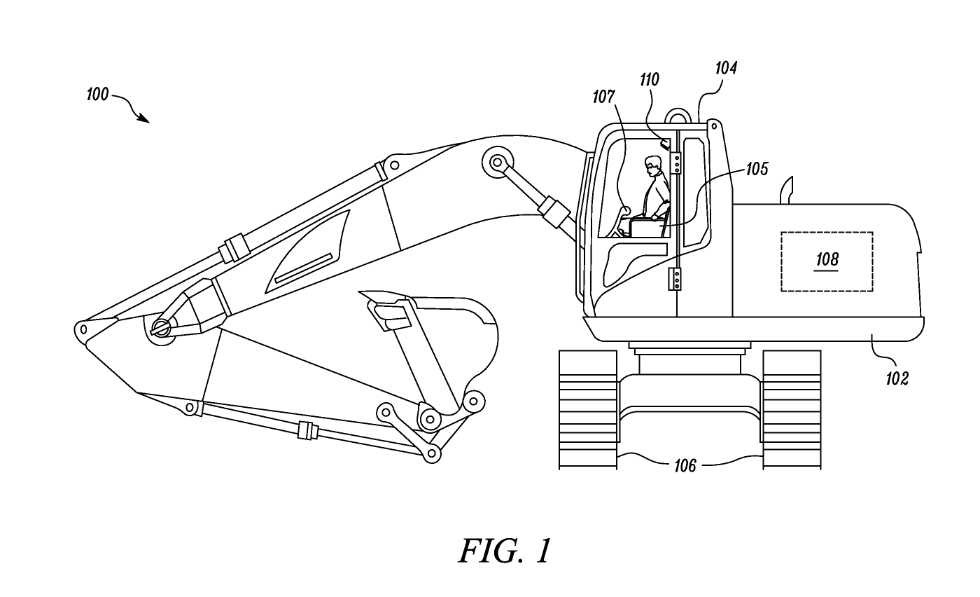

The present disclosure relates to a system and method for controlling operations of a compressor in an air conditioning system. FIG. 1 illustrates an exemplary machine 100, according to an embodiment of the present disclosure. As shown in FIG. 1, the machine 100 may be embodied as a hydraulic excavator. In various other aspects, the machine 100 may be a grader, a dozer, a wheel loader or any other machine which may perform various operations associated with an industry such as mining, construction, farming, transportation, or any other industry known in the art.

Referring to FIG. 1, the machine 100 may include a frame 102. An operator cab 104 may be mounted to the frame 102. It may be appreciated that the operator cab 104 is illustrated as being an enclosed compartment including an operator's seat 105, and a input console having a plurality of operator input devices 107. The operator input devices 107 could be any type of hand or foot controller, such as a switch or a button, or steering wheel, or levers. The machine 100 may be supported on the ground by a plurality of ground engaging members 106, such as wheels and/or tracks. One or more power sources 108 may be housed within the frame 102 to provide power to one or more onboard auxiliary systems (e.g., to a cooling system, a drive system, a tool system, a lubrication system, etc.). The power source 108 may be a diesel engine, a gasoline engine, a gaseous fuel-powered engine, a hydrogen-powered engine, or any other type of combustion engine known in the art. Alternatively, the power source 108 may be a non-combustion source of power such as a fuel cell, a power storage device, a solar cell, or another suitable source of power. The power source 108 may produce mechanical and/or electrical power output, which may be converted to hydraulic power in the form of pressurized fluid.

Further, the machine 100 may include one or more powered components operatively connected to the power source 108. The power source 108 may provide power to the powered components. In an exemplary aspect, one of the powered components may be an air conditioning system 200 for the operator cab 104. The air conditioning system 200 may include one or more vents 110 to direct air in/out of the operator cab 104.

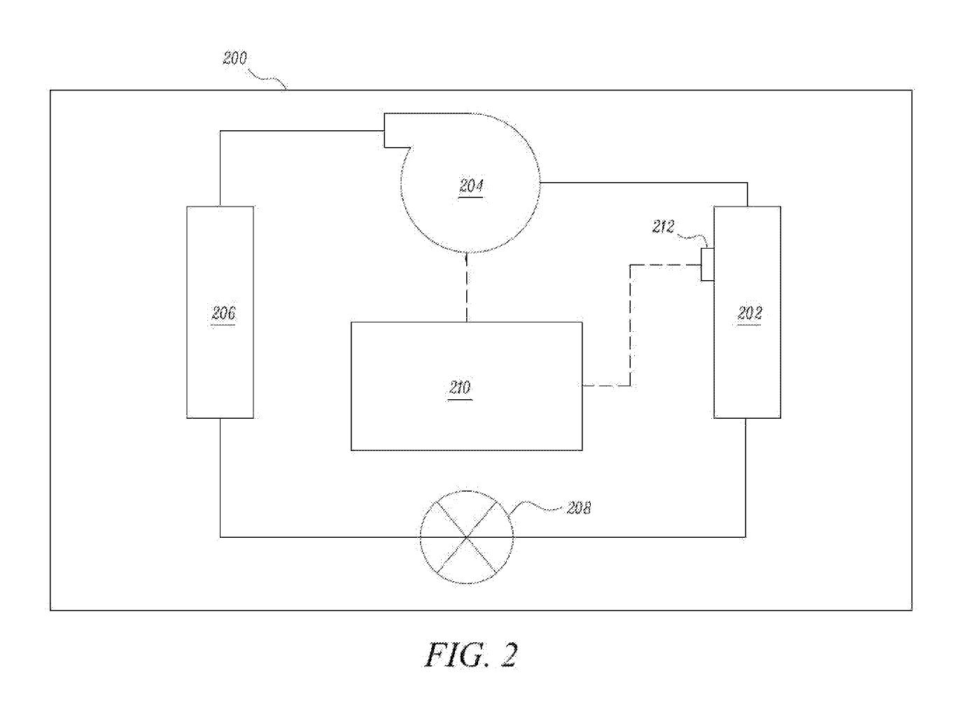

FIG. 2 illustrates an exemplary air conditioning system 200 for the operator cab 104 of the machine 100. In an aspect of the present disclosure, the air conditioning system 200, hereinafter referred to as the system 200, includes an evaporator 202, a compressor 204, a condenser 206, an expansion valve 208 and a controller 210. The evaporator 202 is made up of heat exchanger coils that have a liquid refrigerant flowing through them and a fan (not shown) to flow the air over the evaporator coils of the evaporator 202 and into the operator cab 104 via the vents 110. The refrigerant flowing in the evaporator 202 is configured to absorb heat from the air flowing over it and, thereby increasing the temperature of the refrigerant and causing the air to cool down that provided into the operator cab 104. This increase in temperature causes the refrigerant to convert into a gaseous state.

The system 200 further includes a compressor 204 configured to compress and increase the pressure of the gaseous form of the refrigerant and convert into high pressure gaseous refrigerant. Further, the system 200 includes the condenser 206 configured to cool the refrigerant back to high pressure liquid refrigerant. Further, heat generated in the condenser 206 may be exited to the outside environment via another fan (not shown). Furthermore, the system 200 includes an expansion valve 208 configured to regulate the flow of the high pressure liquid refrigerant into the evaporator 202 from the condenser 206 and also decrease the pressure of the liquid refrigerant at an inlet of the evaporator 202. In an aspect of the present disclosure, the compressor 204 may be directly driven by the power source 108 via a clutch assembly, which may be selectively engaged or disengaged to switch on and off the compressor 204 respectively. Alternatively, the compressor 204 may be electric motor driven.

In an aspect of the present disclosure, the system 200 may include a controller 210 configured to control an operation of the compressor 204 of the system 200. The controller 210 may include any appropriate type of a general purpose computer, special purpose computer, microprocessor, microcontroller, or other programmable data processing apparatus. The controller 210 is configured to determine an operational state of the compressor 204. In an exemplary embodiment, the controller 210 is configured to determine whether the compressor 204 is in an ON state or in an OFF state. Further, the controller 210 is configured to selectively maintain a predefined compressor run time when the compressor 204 is in the ON state. For example, the predefined specified period of the compressor 204 runtime is 30 seconds. In an exemplary embodiment, the system 200 may include a number of speed sensors (not shown) associated with the compressor. The speed sensors may be configured to determine, based on the speed of the compressor (or a compressor fan), whether the compressor 204 is in the ON state or the OFF state. Further, the speed sensors may be configured to send a signal to the controller 210 indicative of the operating state of the compressor 204.

Further, as the controller 210 determines that the compressor 204 is in the ON state for more than a first predetermined time, such as the predefined run time, the controller 210 may be configured to determine a temperature associated with the evaporator 202, such as by using one or more sensors 212 associated with the evaporator 202. For example, the sensors 212 may be temperature sensors positioned across the evaporator 202 at multiple locations and an average temperature may be evaluated using the detected temperature of the evaporator 202 at these various locations. In an exemplary aspect of the present disclosure, the sensors 212 may be a passive solid state temperature sensor which may be coupled to fins of the evaporator 202 and/or at a coldest location of the evaporator 202. In an exemplary embodiment, the temperature of the evaporator 202 may be the temperature of the fins and/or the temperature of the refrigerant flowing through the evaporator 202. The sensors 212 may be further configured to generate and send an input signal to the controller 210. The input signal may be indicative of a real time temperature Tₑᵥₐₚ of the evaporator 202. In an alternate aspect of the present disclosure, there may be a single sensor disposed on the evaporator 202 and be configured to determine the real time temperature of the evaporator 202. In an embodiment, the sensors 212 may be coupled to evaporator fins (not shown) of the evaporator 202 and the real time temperature Tₑᵥₐₚ may be an evaporator fins temperature and/or an evaporator refrigerant temperature.

Further, the controller 210 may be configured to compare the determined evaporator temperature Tₑᵥₐₚ to a lower threshold temperature value for a time period. In an aspect of the present disclosure, the controller 210 is configured to compare the real time temperature Tₑᵥₐₚ of the evaporator 202 to a first lower threshold temperature value LT1 for greater than or equal to a first time period P1 and a second lower threshold temperature value LT2 for greater than or equal to a second time period P2. The second lower threshold temperature value LT2 is being less than the first lower threshold temperature value LT1 and the second time period P2 is being less than the first time period P1. In an exemplary embodiment of the present disclosure, the first lower threshold temperature value LT1 is in a range of about −0.5 degree Celsius to −1 degrees Celsius and the first time period P1 is about 20 seconds to 30 seconds, whereas the second lower threshold temperature value LT2 is in a range of about −1.5 degree Celsius to −2 degrees Celsius and the second time period P2 is in a range of about 1 to 5 seconds.

Furthermore, the controller 210 is configured to output a compressor control command signal to change the operational state of the compressor 204 to an OFF state based on the comparison of the real time temperature Tₑᵥₐₚ of the evaporator 202 with the lower threshold temperature value for the time period. For example, if the real time temperature Tₑᵥₐₚ of the evaporator 202 is determined to be less than −1 degrees Celsius for more than or equal to 30 seconds, then the controller 210 may output the compressor control command to turn the compressor 204 to the OFF state. However, if the real time temperature Tₑᵥₐₚ of the evaporator 202 is determined to be less than −2 degrees Celsius for more than or equal to 2 seconds, then the controller 210 output the compressor control command to turn the compressor 204 to the OFF state.

Furthermore, if the controller 210 determines that the output compressor control command has changed the operational state of the compressor 204 to the OFF state, then the controller 210 may be configured to determine whether real time temperature Tₑᵥₐₚ of the evaporator 202 is greater than a third threshold temperature value T3. In an exemplary embodiment, the third threshold temperature value T3 is about 8 degrees Celsius. The controller 210 is configured to output a compressor control command to turn the compressor 204 back to the ON state. For example, when the controller 210 determines that the real time temperature Tₑᵥₐₚ of the evaporator 202 is equal to or greater than 8 degrees Celsius, then the controller 210 may be configured to output the compressor control command to turn the compressor 204 back to the ON state.

Furthermore, if the controller 210 determines that the compressor 204 is at an OFF state, i.e., when the air conditioning system 200 is completely turned off, then the controller 210 may be configured to determine whether the real time temperature Tₑᵥₐₚ of the evaporator 202 is greater than the second lower threshold temperature value LT2, i.e., −2 degrees. The controller 210 is configured to output a compressor control command to turn the compressor 204 back to the ON state.

Although, the description is with respect to specific temperatures and time durations, it may be well understood by a person having ordinary skill in the art, that the described temperatures and the time durations are merely exemplary, and may be varied based on various environmental conditions, without limiting the scope of the present disclosure.

### INDUSTRIAL APPLICABILITY

The industrial applicability of the air conditioning system 200 for the operator cab 104 of the machine 100, described herein will be readily appreciated from the foregoing discussion.

Air conditioners have been very well known for cooling an environment, such as a car, a room or an operator cab of a machine, to which the air conditioner is fitted. However, during run time of the compressor, excessive ice may be accumulated on the outer surface of the evaporator. Accumulation of ice on the outer surface of the evaporator may not be desired as it adversely affects the performance of the air conditioners and also reduces the life of the air conditioners. One way to reduce the excessive icing on the evaporator is to turn off the compressor. However, turning off the compressor too frequently would increase unnecessary strain on a driving mechanism of the compressor. Whereas, turning off the compressor for a long time may also effect the cooling the environment. Therefore, for effective cooling, turning off the compressor for a long time is not advisable.

The air conditioning system 200 of the present disclosure includes the controller 210 to maintain an optimum runtime of the compressor 204 without increasing strain on the compressor 204 and the clutching mechanism which operates the compressor 204. Also, the controller 210 continuously monitors the temperature of the evaporator 202 to selectively switch the compressor 204 to the ON and/or the OFF state to prevent excessive icing on the evaporator 202. This provides maintaining an effective cooling of the operator cab 104, as the compressor 204 is not turned off for a very long time and also reduces the strain on the compressor 204. Furthermore, monitoring the temperature of the evaporator 202 facilitates the controller 210 to prevent excessive icing on the evaporator 202.

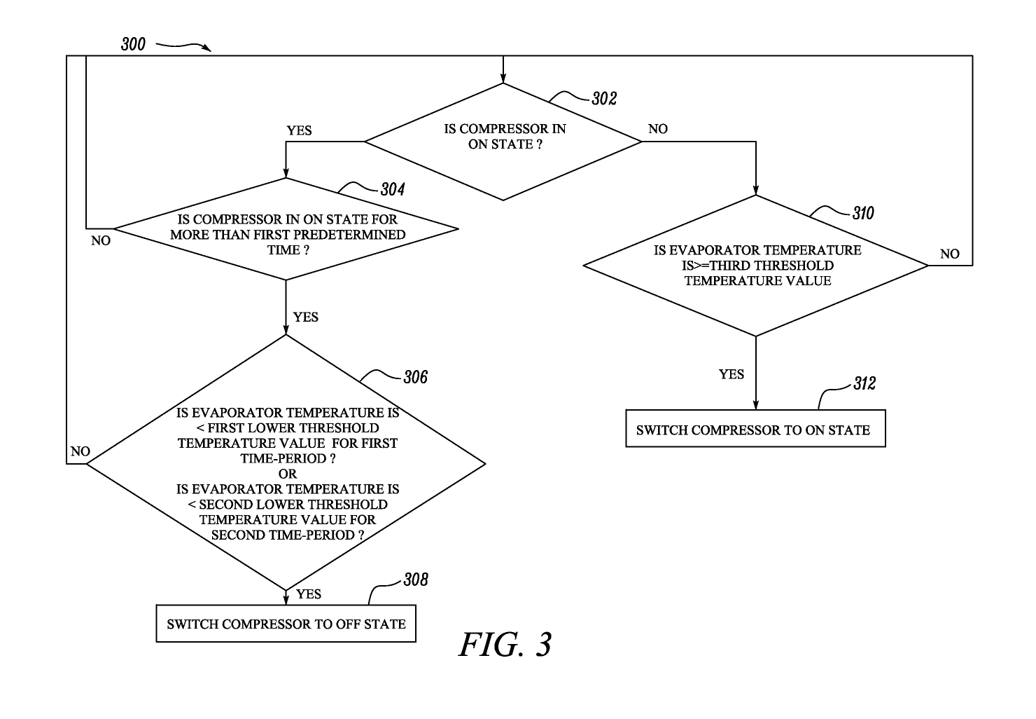

FIG. 3 illustrates a flowchart of an exemplary method 300 for controlling operations of the compressor 204 of the air conditioning system 200. At step 302, it is determined whether the compressor 204 is in the ON state. For example, the operational state of the compressor 204 is determined. In an aspect of the present disclosure, the controller 210 is configured to determine whether the compressor 204 is in an ON state or in an OFF state.

At step 304, it is determined whether the compressor 204 is in the ON state for more than the first pre-determined time. In an aspect of the present disclosure, the controller 210 determines if the compressor 204 is in the ON state for more than 30 seconds.

If it is determined that the compressor 204 is in the ON state for more than 30 seconds, i.e., the YES branch, then the control is sent to step 306. Whereas, if it is determined that the compressor 204 is in the ON state not for more than 30 seconds, i.e., the NO branch, then the control is sent back to the step 302.

At step 306, it is further determined if the real time temperature Tₑᵥₐₚ of the evaporator 202 is less than the first lower threshold temperature value LT1 for the first time period P1 or if the real time temperature Tₑᵥₐₚ of the evaporator 202 is less than the second lower threshold temperature value LT2 for the second time period P2. In an exemplary embodiment of the present disclosure, the controller 210 may be configured to determine the real time temperature Tₑᵥₐₚ of the evaporator 202, such as by using the one or more sensors 212 associated with the evaporator 202. Further, the controller 210 is configured to compare the determined real time temperature Tₑᵥₐₚ of the evaporator 202 to the first lower threshold temperature value LT1 for the first time period P1 and the second lower threshold temperature value LT2 for the second time period P2. The second lower threshold temperature value LT2 is being less than the first lower threshold temperature value LT1 and the second time period P2 is being less than the first time period P1. In an exemplary embodiment of the present disclosure, the first lower threshold temperature value LT1 is in a range of about −0.5 degree Celsius to −1 degrees Celsius and the first time period P1 is in the range of about 20 to 30 seconds, whereas the second lower threshold temperature value LT2 is in the range of about −1.5 degree Celsius to −2 degrees Celsius and the second time period P2 is in the range of about 1 to 5 seconds.

Further, if at step 306, it is determined that the real time temperature Tₑᵥₐₚ of the evaporator 202 is less than the first lower threshold temperature value LT1 for the first time period P1 or if the real time temperature Tₑᵥₐₚ of the evaporator 202 is less than the second lower threshold temperature value LT2 for the second time period P2, i.e., the YES branch, then the control is sent to step 308. However, if the condition at step 306 is not met, i.e., the NO branch, then the control is sent back to step 302.

Furthermore, at step 308, the compressor 204 is switched to the OFF state. In an aspect of the present disclosure, the controller 210 is configured to output the compressor control command to turn the compressor 204 to the OFF state. For example, if the real time temperature Tₑᵥₐₚ of the evaporator 202 is determined to be less than −1 degrees Celsius for about 30 seconds, then the controller 210 may output the compressor control command to turn the compressor 204 to the OFF state. Whereas, if the real time temperature Tₑᵥₐₚ of the evaporator 202 is determined to be less than −2 degrees Celsius for about 2 seconds, then also the controller 210 may output the compressor control command to turn the compressor 204 to the OFF state.

In an aspect of the present disclosure, if at step 302, it is determined that the compressor 204 is in the OFF state, i.e., the NO branch, then the control is sent to step 310. At step 310, it is determined if the real time temperature Tₑᵥₐₚ of the evaporator 202 is greater than or equal to the third threshold temperature value T3. In an exemplary embodiment, the controller 210 is configured to determine if the real time temperature Tₑᵥₐₚ of the evaporator 202 is greater than or equal to about 8 degrees Celsius. If it is determined that the real time temperature Tₑᵥₐₚ of the evaporator 202 is greater than or equal to the third threshold temperature value T3, i.e., the YES branch, then the control is sent to step 312. At step 312, the compressor 204 is switched to the ON state.

In an aspect of the present disclosure, if it is determined that the entire air conditioning system 200 is turned to ON state from the OFF state, then the controller 210 determines if the real time temperature Tₑᵥₐₚ of the evaporator 202 is greater than or equal to the second lower threshold temperature value LT2, i.e., −2 degrees. The compressor 204 is then turned to the ON state.

While aspects of the present disclosure have been particularly shown and described with reference to the embodiments above, it will be understood by those skilled in the art that various additional embodiments may be contemplated by the modification of the disclosed systems and methods without departing from the spirit and scope of what is disclosed. Such embodiments should be understood to fall within the scope of the present disclosure as determined based upon the claims and any equivalents thereof.

What is claimed is:

1. An air conditioning system for use within an operator cab of a machine, comprising:
a condenser;
an evaporator;
a compressor, and
a controller operable to control an operation of the compressor, the controller is configured to:
determine an operational state of the compressor;
selectively maintain a pre-defined compressor run time when the compressor in an ON state;
determine a temperature of the evaporator;
compare the determined temperature of the evaporator with at least one of a first lower threshold temperature value and a second lower threshold temperature value being less than the first lower threshold temperature value; and
output a compressor control command signal to change the operational state of the compressor to an OFF state when the determined temperature of the evaporator is less than at least one of the first lower threshold temperature value for a first time period, and the second lower threshold temperature value for a second time period being less than the first time period.

2. The air conditioning system of claim 1, wherein the pre-defined compressor run time is about 30 seconds.

3. The air conditioning system of claim 1, wherein the first lower threshold temperature value is about −1 degree Celsius and the first time period is about 30 seconds.

4. The air conditioning system of claim 1, wherein the second lower threshold temperature value is about −2 degree Celsius and the second time period is about 2 seconds.

5. The air conditioning system of claim 1, wherein the controller is further configured to determine the temperature of the evaporator after the output compressor command to change the operational state of the compressor to the OFF state is activated.

6. The air conditioning system of claim 5, wherein the controller is further configured to compare the determined temperature of the evaporator with a third threshold temperature value and output a compressor control command to change the operational state of the compressor to the ON state when the evaporator temperature is greater than the third threshold temperature value.

7. The air conditioning system of claim 6, wherein the third threshold temperature value is about 8 degree Celsius.

8. A machine comprising:
an operator cab; and
an air conditioning system configured to provide conditioned air to the operator cab, the air conditioning system including:
a condenser;
an evaporator;
a compressor, and
a controller operable to control an operation of the compressor, the controller is configured to:
determine an operational state of the compressor;
selectively maintain a pre-defined compressor run time when the compressor in an ON state;
determine a temperature of the evaporator;
compare the determined temperature of the evaporator with at least one of a first lower threshold temperature value and a second lower threshold temperature value being less than the first lower threshold temperature value; and
output a compressor control command signal to change the operational state of the compressor to an OFF state when the determined temperature of the evaporator is less than at least one of the first lower threshold temperature value for a first time period, and the second lower threshold temperature value for a second time period being less than the first time period.

9. The machine of claim 10 further including a power source operatively connected to the compressor of the air conditioning system via a clutch assembly, wherein the output compressor control command is operative to selectively engage and disengage the clutch assembly.

10. The machine of claim 10, wherein the pre-defined compressor run time is about 30 seconds.

11. The machine of claim 10, wherein the first lower threshold temperature value is about −1 degree Celsius and the first time period is about 30 seconds.

12. The machine of claim 10, wherein the second lower threshold temperature value is about −2 degree Celsius and the second time period is about 2 seconds.

13. The machine of claim 10, wherein the controller is further configured to determine the temperature of the evaporator after the output compressor command to change the operational state of the compressor to the OFF state is activated.

14. The machine of claim 13, wherein the controller is further configured to compare the determined temperature of the evaporator with a third threshold temperature value and output a compressor control command to change the operational state of the compressor to the ON state when the evaporator temperature is greater than the third threshold temperature value.

15. The machine of claim 14, wherein the third threshold temperature value is about 8 degree Celsius.

16. A method of operating an air conditioning system of a machine comprising:
determining an operational state of a compressor of the air conditioning system;
maintaining a pre-defined compressor run time when the compressor is in an ON state;
determining a temperature of the evaporator;
comparing the determined temperature of the evaporator with at least one of a first lower threshold temperature value and a second lower threshold temperature value being less than the first lower threshold temperature value; and
outputting a compressor control command to turn the compressor to an OFF state when the determined temperature of the evaporator is less than at least one of the first lower threshold temperature value for a first time period, and the second lower threshold temperature value for a second time period being less than the first time period.

17. The method of claim 16, wherein maintaining a pre-defined compressor run time further comprises comparing the compressor run time with a first predetermined time.

18. The method of claim 16 further comprising determining the temperature of the evaporator after outputting the compressor command to change the operational state of the compressor to the OFF state is activated

19. The method of claim 18 further comprises comparing the determined temperature of the evaporator with a third threshold temperature value.

20. The method of claim 19 further comprises outputting a compressor control command to change the operational state of the compressor to the ON state when the evaporator temperature is greater than the third threshold temperature value.
